(19) United States
(12) Patent Application Publication
(10) Pub. No.: US 2025/0363325 A1
(43) Pub. Date: Nov. 27, 2025

(54) CARD BODY AND LIGHT GUIDE BODY FOR A PORTABLE DATA CARRIER AND SAME

(71) Applicant: Giesecke+Devrient ePayments GmbH, Munchen (DE)

(72) Inventors: Thomas Tarantino, Munich (DE); Peter Reiss, Munich (DE)

(73) Assignee: Giesecke+Devrient ePayments GmbH, Munchen (DE)

(21) Appl. No.: 19/216,259

(22) Filed: May 22, 2025

(30) Foreign Application Priority Data
May 24, 2024 (DE) 102024114710.5

(51) Int. Cl. G06K 19/077; G06K 19/07

(52) U.S. Cl. CPC G06K 19/0772; G06K 19/0723; G06K 19/07705

(57) ABSTRACT

The present disclosure relates to a card body for a portable data carrier, having a light guide body receptacle for receiving a light guide body, the light guide body receptacle being arranged so as to be accessible from outside the card body for manually inserting the light guide body into and/or removing the light guide body from the card body, a light guide body which can be manually inserted or removed from a light guide body receptacle of a corresponding card body, and a portable data carrier having a corresponding card body and/or a corresponding light guide body, and a portable data carrier with a corresponding card body and/or a corresponding light guide body.

### CROSS REFERENCE TO RELATED DOCUMENT(S)

This application claims priority to and the benefit of DE Application No. 10 2024 114 710.5 entitled “Card Body and Light Guide Body for a portable Data Carrier and Same” and filed on May 24, 2024, which application is incorporated by reference in its entirety.

### TECHNICAL FIELD

The present disclosure relates to portable data carriers which can be customized by means of light guide bodies which can be accommodated therein. In particular, the present disclosure relates to a card body for a portable data carrier, with a light guide body receptacle for receiving a light guide body, a light guide body for a portable data carrier and a portable data carrier.

### BACKGROUND

Portable data carriers are known from the state of the art and can be used, for example, for cashless payment of goods or services, for personal identification and/or for access to Internet-based application programs. Accordingly, there are, for example, card-shaped data carriers in the form of chip cards in general, payment cards, such as credit cards or debit cards, as well as ID cards or identity cards. Such data carriers usually comprise an electronic circuit with an electronic component, such as a chip, which can be accessed in order to read data from it and, based on this, allow a legitimate owner of the data carrier to perform and/or authorize a specific action. In addition, portable data carriers can include optical elements that can serve both decorative and security purposes.

EP 4 109 337 A1, for example, describes a transaction card comprising at least one metal layer with one or more openings. An optical fiber is arranged under the metal layer. The light guide has a light output and a light input. The light output is positioned so that light is transmitted through at least one or more openings in the metal layer. At least one LED is positioned so that it transmits light into the light guide light input.

DE 10 2014 015277 A1 relates to a data carrier with a light source and a graphic element, wherein the appearance of the graphic element can be changed by a light source arranged in a body of the data carrier as a function of the switching state of the light source. The data carrier comprises a light guide that can be illuminated by the light source, wherein the light guide comprises a transparent section. A surface is arranged below the transparent section of the light guide, at least in the area of the graphic element, which is perceptible when the light source is switched off.

### SUMMARY

The present disclosure provides portable data carriers with optical elements that can be manufactured as simply and inexpensively as possible. One or more embodiments herein can improve design options for optical elements for portable data carriers. Furthermore, they can make it possible to customize portable data carriers with optical elements as freely as possible.

The embodiments presented with reference to respective card bodies, light guide bodies and/or portable data carriers as described herein apply correspondingly to methods for their manufacture. The present components of card bodies, light guide bodies and/or portable data carriers as described herein can each be formed or configured by corresponding process steps, respectively.

A card body for a portable data carrier is provided, with a light guide body receptacle for receiving a light guide body, wherein the light guide body receptacle is arranged so as to be accessible from outside of the card body for manual insertion of the light guide body into and/or removal of the light guide body from the card body.

A light guide body for a portable data carrier is provided, wherein the light guide body can be manually inserted into and/or removed from a light guide body receptacle of a corresponding card body.

A portable data carrier is provided, comprising a corresponding card body and a corresponding light guide body

In particular, a kit comprising at least one card body and at least one light guide body can be provided. Separate provision of the card body and the light guide body makes their manufacture simple and cost-effective. In addition, the optical effects that can be achieved with the light guide body as an optical element can be designed very freely. The light guide body can be customized to a relatively high degree. Appliers or users can individualize the portable data carrier with light guide bodies designed according to their respective wishes and possibly use or replace them themselves.

According to an embodiment of the card body, it may be provided that the light guide body receptacle is designed to be accessible via at least one engagement recess formed at the card body. The light guide body can be inserted into and/or removed from the light guide body receptacle manually and/or using simple tools via the engagement recess. This helps to further improve the ease of handling and customization of the portable data carrier or the light guide body accommodated therein.

According to an embodiment of the card body, it can be provided that the light guide body receptacle is connected to a light source arranged in the card body via at least one light guide channel in a light-transmitting manner. The light source can be designed according to the respective requirements in order to illuminate the light guide body from the anchored position. In this way, very individual and appealing lighting effects can be achieved.

According to an embodiment of the card body, it may be provided that the light guide body receptacle opens in a longitudinal direction and/or transverse direction of the card body for laterally sliding the light guide body into and/or out of the light guide body receptacle. The light guide body can thus be pushed into or out of the light guide body receptacle. This helps to further improve the handling and customizability of the portable data carrier or the light guide body accommodated therein.

According to an embodiment of the card body, it can be provided that at least one undercut area and/or positive-fit element is arranged in the light guide body receptacle, by means of which the light guide body can be held captive in the light guide body receptacle. For example, the light guide element can be pushed behind the undercut area and/or the positive-fit element. This helps to create a positive-fit connection between the card body and the light guide body in a manner as simply and reliably as possible.

According to an embodiment of the light guide body, it may be provided that the light guide body comprises at least one engagement element for a positive-fit engagement with the light guide body. The engagement element can be attached to the light guide body manually and/or using simple tools in order to insert it into the light guide body receptacle and/or remove it from there. This helps to further improve the ease of handling and customization of the portable data carrier or the light guide body accommodated therein.

According to an embodiment of the light guide body, it can be provided that the light guide body comprises at least one light guiding element, diffusion element and/or aperture element and/or is designed to interact with these. The light guiding element, for example in the form of a glass fiber element or similar, can help to guide light specifically from the light source to a surface of the light guide body that is visible from the outside. Diffusion elements can be used to achieve the required or desired scattering of the light emitted by the light source in accordance with the respective requirements. The aperture element can be used to create the desired lighting effects, such as shading, contours or similar. This helps to further improve the variety of optical lighting effects and their individual design options.

One or more embodiments as described herein can be less complex and less costly to manufacture with optical elements attached to them as well as improving optical effects that can be achieved with the optical elements. The customizability of the optical elements can also be a characteristic of such one or more embodiments.

According to an embodiment of the light guide body, it may be provided that the light guide body comprises at least one security element and/or is designed to interact with it, the at least one security element being configured to indicate its loss of validity when the light guide body is removed from the light guide body receptacle. In this way, the light guide body can fulfill a security function. For example, the at least one security element can be arranged on the light guide body, on the card body and/or between the light guide body and can be anchored. Thereby, the at least one security element can be destroyed, damaged or otherwise influenced when the light guide body is removed from the light guide body receptacle in order to indicate tampering or invalidity. In this way, the security of portable data carriers can be further improved.

### BRIEF DESCRIPTION OF THE DRAWINGS

The present disclosure will hereinafter be described in conjunction with the following figures, wherein:

FIG. 1 depicts a schematic top view of an embodiment of a portable data carrier comprising a card body with a light guide body accommodated therein.

FIG. 2 depicts a schematic cross-sectional view of the portable data carrier from FIG. 1 along a sectional line A-A drawn therein.

FIG. 3 depicts a schematic top view of a further embodiment of a portable data carrier comprising a card body with a light guide body accommodated therein.

FIG. 4 depicts a schematic cross-sectional view of the portable data carrier of FIG. 3 along a sectional line B-B drawn therein.

FIG. 5 depicts a schematic top view of an additional embodiment of a portable data carrier comprising a card body with a light guide body accommodated therein.

FIG. 6 depicts a schematic cross-sectional view of the portable data carrier from FIG. 5 along a sectional line C-C drawn therein.

FIG. 7 depicts a schematic cross-sectional view of a light guide body with light guide elements above a light source along the sectional line A-A shown in FIG. 1.

FIG. 8 depicts a schematic cross-sectional view of a light guide body with aperture elements above a light source along the sectional line A-A shown in FIG. 1.

FIG. 9 depicts a schematic cross-sectional view of a light guide body with diffusion elements above a light source along the sectional line A-A shown in FIG. 1.

In the figures, identical or functionally identical elements are marked with the same reference symbols.

### DETAILED DESCRIPTION

The illustrations in the figures are schematic and not to scale. If the same reference signs are used in different figures in the following description of the figures, these designate the same or similar elements. However, identical or similar elements may also be designated by different reference signs.

FIG. 1 shows a schematic top view of an embodiment of a portable data carrier 1, which comprises a card body 2 with a light guide body receptacle 3 and a light guide body 4 accommodated therein. In addition, the portable data carrier 1 can comprise a data carrier module 5. The portable data carrier 1 extends in a longitudinal direction X, a transverse direction Y and a vertical direction Z, which together constitute a Cartesian coordinate system.

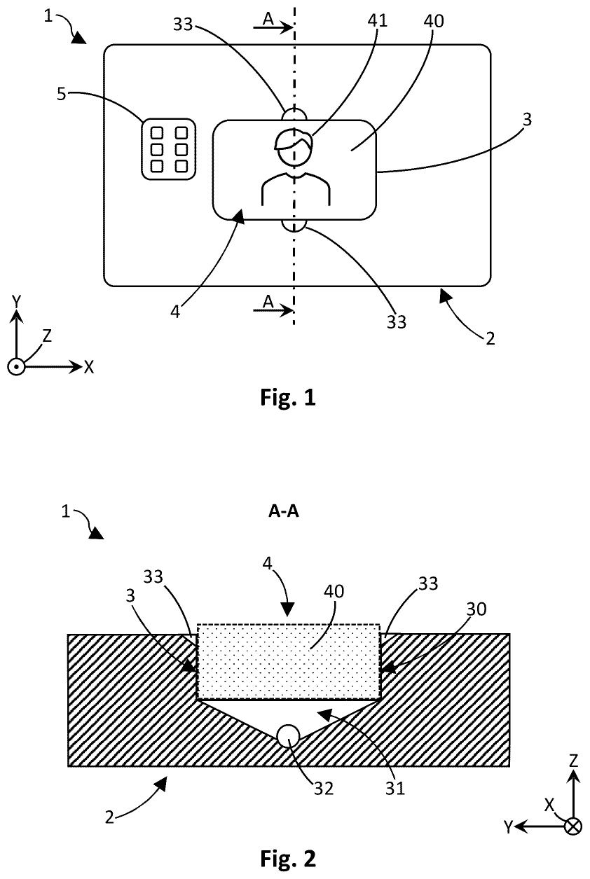

The light guide body receptacle 3 can comprise a receiving area 30 and an illumination area 31 (see FIG. 2). At least one light source 32 is provided, which can be arranged in the illumination area 31, for example in the form of one or more light-emitting diodes (LEDs), which can be arranged and designed according to the respective requirements (see FIG. 2). At the side of the light guide body receptacle 3, in particular at the receiving area 30, engagement recesses 33 can be formed, which can allow a lateral access in the longitudinal direction X and/or the transverse direction Y to the light guide body 4 held in the light guide body receptacle 3 by providing lateral openings to the light guide body receptacle 3.

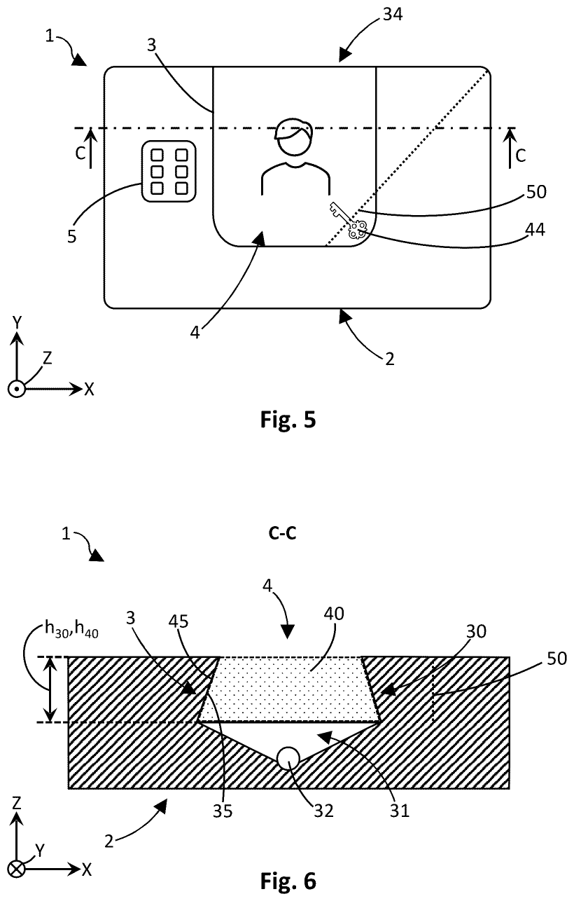

The light guide body 4 can comprise a base body 40 with a picture element 41 and a security element 42 (see FIG. 5). Engagement elements 43 can be formed on the side of the base body 40 (see FIG. 4). The engagement elements 43 can be formed in the form of recesses, notches and/or incisions in the respective side surfaces of the base body 40 in order to enable positive-fit engagement on the base body 40, for example so that forces in and/or against the height direction Z can be transmitted to the base body 40 via the positive fit established in order to simplify insertion or removal of the light guide body 4 into or from the light guide body receptacle 3, respectively.

In the non-limiting examples, the light guide 4 can therefore be placed permanently or removably in a light guide receptacle 3 formed as a pocket in the card body 2. The light source 32 can be located either below the bottom of the pocket or at the wall of the pocket. The position of the light guide body 4 on the card body 2 can be guaranteed by the pocket. This ensures that light from the light source 32 is directed into the light guide body 4. A surface of the light guide body 4 that is visible from the outside can be flush with the card body 2, protrude from it and/or be recessed into it.

If the light guide body 4 constitutes a security feature, for example by having a security element 42 and/or interacting with it, this should lose its validity when the light guide body 4 is removed from the card body. It should be ensured that the security feature cannot be reused in another card body. One way of achieving this would be a predetermined breaking point 50, which can be formed or attached to the card body 2, the light guide body 4 and/or the security element 44 (see FIG. 5). In this way, the card body 2, light guide body 4 and/or security element 44 can break at the predetermined breaking point 50 when the light guide body 4 is removed from the light guide body receptacle 3, so that it cannot be reused.

Alternatively, or additionally, the security element 44 can be designed as an integrated seal, which is visibly destroyed when the element is removed and makes the invalidity of the security feature visible. If the light guide element 4 is an individualization element, it can be designed in such a way that it can be removed and reinserted several times. As an image element 41 and/or security element 42, 2D images (symbols, characters, logos, texts) and 3D bodies/holograms can be illuminated by the light source 32.

FIG. 2 shows a schematic cross-sectional view of the portable data carrier of FIG. 1 along a sectional line A-A drawn therein. It can be seen here that the light guide body 4 can be received and held in the receiving area 30 of the light guide body receptacle 3, for example by being glued and/or latched to side walls of the receiving area 30 or alike. The illumination area 31 of the light guide body receptacle 3, in which the light source 32 is arranged, is arranged below the light guide 4.

For example, the illumination area 31 can open from the light source 32 as a kind of light guide channel in the shape of a funnel towards the receiving area 30 in order to enable the largest possible area of illumination on the underside of the light guide body 4 facing the light source 32. For this purpose, the illumination area 31 can be triangular in shape, at least in cross-section. For example, the illumination area 31 can have a pyramidal, conical and/or frustoconical shape.

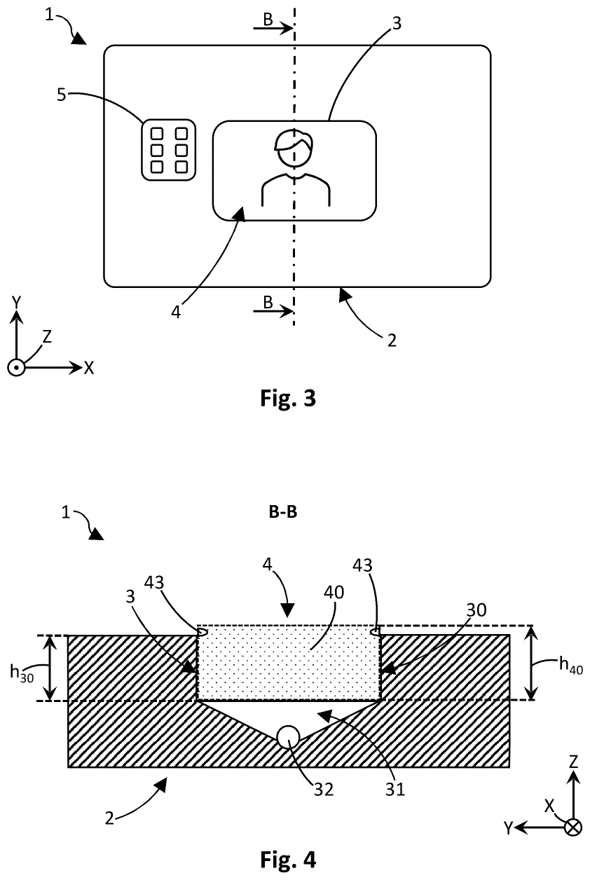

FIG. 3 shows a schematic top view of a further embodiment of a portable data carrier 1, which comprises a card body 2 with a light guide body 4 accommodated therein. FIG. 4 shows a schematic cross-sectional view of the portable data carrier 1 of FIG. 3 along a sectional line B-B depicted therein. Here it becomes evident that a height h30 of the receiving area 30 measured essentially parallel to the height direction Z can be less than a height h40 of the light guide body 4, in particular its base body 40, also measured essentially in parallel to the height direction Z.

In this way, the light guide body 4 can protrude out of the top of the light guide body receptacle 3 in the height direction Z. For example, the engagement elements 43 formed on the light guide 4 can thus be arranged outside the light guide body receptacle 3 so as to be accessible from the side. Alternatively or additionally, a position of engagement recesses 33 on the light guide body receptacle 3 can be adapted to positions of the engagement elements 43 on the light guide body receptacle 4 such that the engagement elements 43 are laterally accessible via the engagement recesses 33, for example when a surface of the card body 2 pointing in the height direction Z and a surface of the light guide body 4 pointing in the height direction Z are aligned with one another, e.g., when the h30 of the receiving area 30 essentially corresponds to the height h40 of the base body 40 of the light guide body 4 (see FIG. 6).

FIG. 5 shows a schematic top view of an additional embodiment of a portable data carrier 1, which comprises a card body 2 with a light guide body 4 accommodated therein. The light guide body receptacle 3 is provided with a side opening 34, via which the light guide body 4 can be pushed in and/or out of the light guide body receptacle 3. The portable data carrier 1 is also provided with a security element 44, which can be arranged in the light guide body receptacle 3 and/or on the light guide body 4.

FIG. 6 shows a schematic cross-sectional view of the portable data carrier 1 from FIG. 5 along a sectional line C-C depicted therein. An undercut area 35 can be formed in the light guide body receptacle 3, in particular in the receiving area 30. The undercut area 35 can interact with an outer contour 45 of the light guide body 4 in order to secure the light guide body 4 against falling out of the light guide body receptacle 3, at least in the height direction Z. For example, the outer contour 45 of the light guide body 4 can be shaped to complement the undercut area 35 in a projection along a pushing direction for pushing the light guide body 4 in or out. In the present example, the outer contour 45 gives the light guide 4 a trapezoidal cross-section that tapers in the height direction Z.

In the present example, the side cheeks of the receiving area 30 formed on the card body 2 have an undercut. The light guide body 4 has beveled side cheeks as an outer contour 45, which have the same angle as the undercut of the card body 2. As a result, a positive fit takes place during insertion, which prevents the light guide body 4 from falling out of the card body 3. In particular, in this example a dovetail joint is formed in order to create a positive fit. Another exemplary way of realizing the positive fit would be a so-called T-slot.

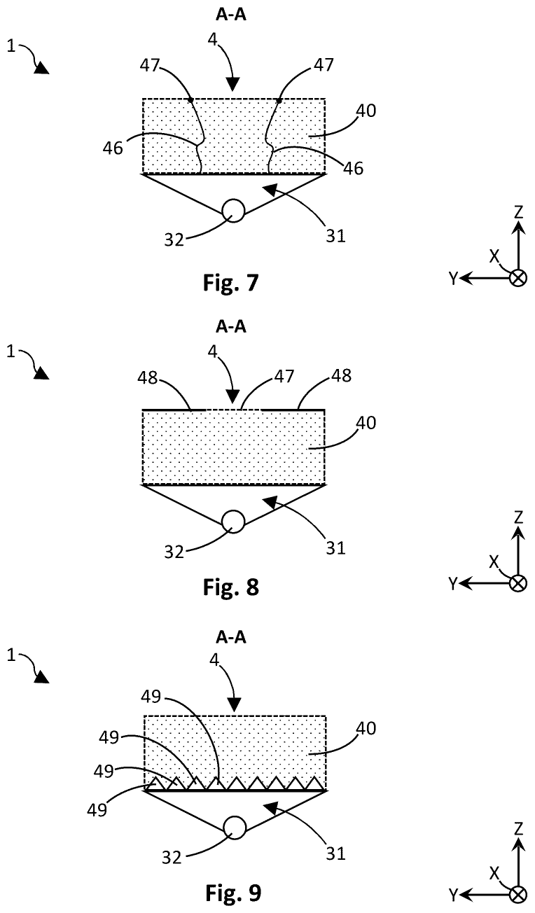

FIG. 7 shows a schematic cross-sectional view of a light guide body 4 with light guide elements 46 above a light source 32 along the sectional line A-A shown in FIG. 1. The light guiding elements 46 can extend from an underside of the light guide body 4 facing the light source 32 to its upper side, for example by penetrating the base body 40 in a similar way to optical fibers. On the underside of the base body 40, the light can be coupled into this or the light guiding elements 46. On or just below the upper side of the light guide body 4, the light guide elements 46 can form light outlets 47 for the coupled light, which can be arranged in a predeterminable pattern and can thus, for example, represent the image element 41 and/or the security element 42.

FIG. 8 shows a schematic cross-sectional view of a light guide body 4 with aperture elements 48 above a light source 32 along the sectional line A-A shown in FIG. 1. The aperture elements 48 can form the light outlet 47 between them as a kind of aperture opening. The light outlet 47 can again, for example, represent the picture element 41 and/or the security element 42.

FIG. 9 shows a schematic cross-sectional view of a light guide 4 with diffusion elements 49 above a light source 32 along the sectional line A-A shown in FIG. 1. The diffusion elements 49 can, for example, be formed on the underside of the light guide body 4 facing the light source 32, arranged at the bottom of the base body 40. In the present example, the diffusion elements 49 are designed as prisms or angular geometries, the base surface of which faces the light source 32.

Light rays from the light source 32 are refracted at the diffusion elements 49. This allows a uniform light distribution to be achieved in the light guide 4. The diffusion elements 49 can have different shapes, depths and refraction angles. In addition, other elements, such as color filters and diffusers for adjusting the light effect, can also be integrated.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Details of the exemplary embodiments or other limitations described above should not be read into the claims absent a clear intention to the contrary. Any implementation described herein as exemplary is not necessarily to be construed as preferred or advantageous over other implementations, and the exemplary embodiments described herein are not intended to limit the scope or applicability of the subject matter in any way. Accordingly, it should be appreciated that the exemplary embodiment or embodiments described herein are not intended to limit the scope, applicability, or configuration of the claimed subject matter in any way. Rather, the foregoing detailed description will provide those with ordinary skill in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

It is claimed:

1. A card body for a portable data carrier, having a light guide body receptacle for receiving a light guide body, wherein the light guide body receptacle is arranged to be accessible from outside of the card body for manual insertion of the light guide body into and removal of the light guide body from the card body.

2. The card body of claim 1, wherein the light guide body receptacle is configured to be accessible via at least one engagement recess formed on the card body.

3. The card body of claim 1, wherein the light guide body receptacle is connected in a light-transmitting manner via at least one light guide channel to a light source arranged in the card body.

4. The card body of claim 1, wherein the light guide body receptacle opens in a longitudinal direction and transverse direction of the card body for laterally sliding the light guide body into and out of the light guide body receptacle.

5. The card body of claim 1, wherein at least one undercut region and positive-fit element is arranged in the light guide body receptacle, by means of which the light guide body can be held captive in the light guide body receptacle.

6. A light guide body for a portable data carrier, wherein the light guide body can be manually inserted into and removed from a light guide body receptacle of a card body arranged to be accessible from outside of the card body for manual insertion of the light guide body into and removal of the light guide body from the card body.

7. The light guide body of claim 6, wherein the light guide body comprises at least one engagement element for engaging the light guide body with a positive-fit.

8. The light guide body of claim 7, wherein the light guide body comprises at least one light guiding element, diffusion element and aperture element and is configured to interact with one of these.

9. The light guide body of claim 8, wherein the light guide body comprises at least one security element and is configured to interact therewith, the at least one security element being adapted to indicate a loss of its validity when removing the light guide body from the light guide body receptacle.

10. A portable data carrier, comprising a card body having a light guide body receptacle for receiving a light guide body, wherein the light guide body receptacle is arranged to be accessible from outside of the card body for manual insertion of the light guide body into and removal of the light guide body from the card body.

11. The portable data carrier of claim 10 further comprising a light guide body.

12. The portable data carrier of claim 10, wherein the light guide body receptacle is accessible via at least one engagement recess formed on the card body.

13. The portable data carrier of claim 10, wherein the light guide body receptacle is connected in a light-transmitting manner via at least one light guide channel to a light source arranged in the card body.

14. The portable data carrier of claim 10, wherein the light guide body receptacle opens in a longitudinal direction and transverse direction of the card body for laterally sliding the light guide body into and out of the light guide body receptacle.

15. The portable data carrier of claim 10, wherein at least one undercut region and positive-fit element is arranged in the light guide body receptacle, by means of which the light guide body can be held captive in the light guide body receptacle.

16. The portable data carrier of claim 11, wherein the light guide body can be manually inserted into and removed from the light guide body receptacle of the card body arranged to be accessible from outside of the card body for manual insertion of the light guide body into and removal of the light guide body from the card body.

17. The portable data carrier of claim 11, wherein the light guide body comprises at least one engagement element for engaging the light guide body with a positive-fit.

18. The portable data carrier of claim 11, wherein the light guide body comprises at least one light guiding element, diffusion element and aperture element and is configured to interact with one of these.

19. The portable data carrier of claim 11, wherein the light guide body comprises at least one security element and is configured to interact therewith, the at least one security element being adapted to indicate a loss of its validity when removing the light guide body from the light guide body receptacle.
